(19) United States
(12) Patent Application Publication
(10) Pub. No.: US 2008/0297357 A1
(43) Pub. Date: Dec. 4, 2008

(54) Motion-sensitive vibrating sleep device

(76) Inventors: Alexander Golbin, Northbrook, IL (US); Leonid Danushevsky, Riverwoods, IL (US)

Correspondence Address: PIONEER PATENT, LLC, P. O. BOX 128, NORTHBROOK, IL, 60065-0128, US

(21) Appl. No.: 11/725,369

(22) Filed: Mar. 19, 2007

Related U.S. Application Data
(60) Provisional application No. 60/783,553, filed on Mar. 17, 2006.

(51) Int. Cl. G08B 23/00

(52) U.S. Cl. 340/573.5

(57) ABSTRACT

A motion-sensitive vibrating sleep device is disclosed that includes a motion sensor and a controller operating a vibratory means. The motion sensor senses motion of a body. The controller causes a vibratory means to be activated when no body motion is detected in a predetermined period of time. Once motion is detected, the controller optionally causes the vibratory motion to cease.

### CROSS-REFERENCE TO RELATED APPLICATIONS

This is a utility patent application, which is based upon provisional U.S. application Ser. No. 60/783,553 “Tool for Bedwetting Control”, filed on Mar. 17, 2006, for which the benefit of the priority date is claimed, and the disclosures of which are incorporated in full herein by reference.

### BACKGROUND OF THE INVENTION

Various approaches are known in the art to address sleep disorders. Some use alarms to awaken sleepers or to alert caregivers of a certain condition, others use medicines, electric or magnetic fields to affect the body. The present invention provides a device that may be useful in a method of helping a body to switch from various stages of sleep, that may provide benefits to the attendant biological effects from switching stages of sleep.

In children with bedwetting, the child does not awaken and experiences enuresis, an uncontrolled or involuntary discharge of urine. Later in life, in many children enuresis spontaneously disappears. However, about 3-5 percent still wet until adolescence or even adulthood, which causes tremendous personal and family distress. Medication treatment to suppress enuresis is very expensive and not very successful in many patients.

The following patent art discloses various devices and methods for use in dealing with bedwetting, bedsores, and insomnia. Many of the bedwetting devices are alarm systems to either wake the sleeper at the first sign of moisture, or to notify a caregiver that a person is wet and may benefit from attention. In many of those cases, the vibrations serve as an alarm to wake the sleeper or provide notice to the caregiver. Also in the art, an example is described below, is a motion-sensitive system that will cause vibration and movement when there has been no motion of the patient detected for a pre-determined amount of time. That system is for the prevention or treatment of bedsores, and a change in the contact of the body with the body support is the goal.

Kanor, et al., U.S. Pat. No. 6,384,728 (May 7, 2002) discloses a personal care monitoring system having at least one condition detecting sensor and a corresponding condition indicator. The condition detecting sensor may indicate detection of wetness, such as caused by enuresis. Alternatively, or additionally, the condition detecting sensor may indicate that the physical position of the wearer of the device has not been adjusted for over a predetermined amount of time after which the likelihood of the development of bedsores increases. The indicator may be any desired type of indicator, preferably alerting one of the senses that the monitored condition has been detected. For instance, the indicator may be a light, an audible alarm, or a vibrating device. A processing means preferably is provided to control operation of the various components of the monitoring system. Moreover, the processing means may be programmed to store information pertaining to the operation of the components of the monitoring system. For example, the time at which a condition has been detected as well as the time at which a care giver has attended to the condition may be recorded. Such information may be retrieved to determine the frequency of care given to the wearer of the monitoring system as well as the amount of time elapsed between occurrence of the monitored condition and attendance to such condition by the care giver.

Ogawa, U.S. Pat. No. 6,505,361 (Jan. 14, 2003) discloses vibration generators for inducing sleep by vibrating the body for use in a method for overcoming insomnia. Ogawa discloses a vibration generator which comprises a rotary drive means having a drive shaft, at least a pair of rotors which is installed on the drive shaft and is rotative in association with the drive shaft, and unbalanced weights which are respectively installed in the rotors; and an apparatus for controlling the function of living bodies, which comprises the vibration generator as a vibration generating source.

Fisher, et al. U.S. Pat. No. 5,790,036 (Aug. 4, 1998) and Fisher, et al. U.S. Pat. No. 5,557,263 disclose systems and sensors for use in detection of electrically conductive fluids. The disclosed apparatus is for detecting the presence of electrically conductive fluids, including urine and other body fluids such as exudate from wounds, includes a pair of spaced-apart electrodes covered by absorbent material, together with a housing containing a signaling device which produces a palpable vibration, a sound, a light, or a radio signal when fluid in the absorbent material provides a conductive path between the electrodes. Spring contacts on the housing provide reliable connections with the electrodes and also serve to attach the housing of the signaling device to structure supporting the absorbent material, and may also be used to attach the absorbent material to the housing in embodiments where the housing is otherwise supported. Disposable sensing pad material which is comfortably soft and flexible can be produced in indefinite lengths with moisture-previous outer layers and an inner layer of absorbent thermally-weldable material. Encoded signals from many such sensors can be identifiably related to and recorded so as to be machine-retrievable together with other patient data and analyzed statistically by a computer.

Randolph, U.S. Pat. No. 7,151,458 (Dec. 19, 2006) discloses a discreet bed-wetting alarm and method of use thereof. The discreet bed-wetting alarm comprises a controller, earpiece with earphone, and interconnecting cable. The controller comprises a clock/processor with timer, a display, a sound signal/tone generator, an amplifier programmed to provide an increase in sound volume level, a battery, and various input devices. A plurality of alarm time selections corresponding to known bed-wetting event times is subsequently made and a suitable alarm tone or tones is selected to awaken or alert the user. The discreet bed-wetting alarm controller and earphone may be incorporated into the earpiece for further discretion. Alternate embodiments include a vibrating alarm and/or a flashing light alarm.

Shapira, et al., U.S. Pat. No. 6,916,968 (Jul. 12, 2005) discloses a urine detection system and method that includes generating a magnetic field within an effective distance of a potentially wetted area.

Ishikawa, et al. U.S. Pat. No. 5,984,854 (Nov. 16, 1999) discloses a method for treating urinary incontinence and apparatus therefor. The method for treating urinary incontinence which consists of delivering a train of current pulses through one or more magnetic stimulation coils to induce a train of magnetic flux pulses, which then induce an eddy current within the body, thereby to stimulate a group of pelvic floor muscles, the pudendal nerve, the external urethral sphincter, or the tibial nerve.

The present invention takes a new approach to the problem of providing a device that may be useful in a method of helping a body to switch from various stages of sleep, that may provide benefits to the attendant biological effects from switching stages of sleep. It is a goal of the invention to provide vibratory action to a body when it has not moved in a predetermined amount of time.

### BRIEF SUMMARY OF THE INVENTION

The present invention provides a device or system for monitoring a personal condition, body movement or lack therof. The device or system causes a vibratory motion when there has been a lack of body movement or change in body position for a predetermined amount of time. The device or system of the invention includes a mat upon which a person sleeps. The mat includes one or more body motion/position sensors to detect motion, or lack thereof, of the sleeper upon the mat, and optionally also the body position of the sleeper. The device also includes a vibrating means. When the sensors show that no movement of the sleeper has been detected for a predetermined amount of time, the vibrating component provides vibrational action until motion of the sleeper is detected. In a preferred embodiment, the device also detects body position, such as when there is a sleeper on the mat. The device optionally also provides an alarm when its operating power is low.

### BRIEF SUMMARY OF THE DRAWINGS

In the drawings forming a portion of the disclosure:

FIG. 1 shows a schematic circuit diagram of an embodiment of a position- and motion-sensitive vibrating sleep mat of the invention. The main components of the circuit are a microcontroller U2, accelerometer U1, buzzer B1, LED and vibrator motor M1. Q1 and Q2 are amplifier transistors that are used for the buzzer and the motor respectively.

### DETAILED DESCRIPTION OF THE INVENTION

The present invention provides a sleep aid that will help some people overcome bedwetting. It is presently thought in the art that there are many types, multiple causes, and complicated dynamics of bedwetting. The device of the present invention, SLEEP DOC™ is designed as hygienic only, not as a therapeutic device. The tool for bedwetting control may be used as an adjunct to the treatment of the primary condition and a part of a complete enuresis management plan.

Not wishing to be bound by theory, the tool for bedwetting control of the present invention is designed to help a user break the cycle of bedwetting that may be associated with sleep architecture. The sleep architecture hypothesis as one possible cause of bedwetting arose from the analysis of sleep of approximately 500 bedwetters. Observers noted that bedwetting occurs for some “reason” to maintain or switch sleep stages when the natural “switches” are broken or not developed.

The sleep process consists of repetitive cycles of five stages (4 in so called NREM and 1-REM). Four stages of Non-REM sleep are those that we observe as a calm sleep—slow breathing, slow pulse, slow large movements and changes in body positions. These four stages of “slow” sleep are followed by about 60 minutes of the phase when eyes start moving really fast (that is why this stage is called: Rapid Eye Movements (REM) stage). Each stage has its own metabolism; cyclic and timing are very important for health.

In children with bedwetting, the switch from one stage to another is delayed, especially during the first half of the night. That is why sleep in these children appears too deep. The act of bedwetting is actively “set up” by the body. A strong stream of impulses from this old reflex is coming up to the brain and makes the brain move (“switch”) to the next stage. Normally, all of us have developed such switchers as changing body positions, scratching, or otherwise moving, which produce the stages to shift. Later in life, when the normal “switches” are developed, in many children enuresis spontaneously disappears. However, about 3-5 percent still wet until adolescence or even adulthood, which causes tremendous personal and family distress. Under this theory, medical treatments based upon-suppression of enuresis fail, because they aim to suppress the act of enuresis but not to treat its cause, which is the failure to develop switches.

The SLEEP DOC™ device produces a natural substitution for bedwetting by “sensing” the most probable time and position in which most wetting episodes occurs. A quiet non-disturbing vibro-stimulation is emanated from SLEEP DOC™ onto the sleeping child in a way that the child will change the body position, scratch, or move otherwise enough to switch stages and consequently, prevent the act of bedwetting. After several weeks of using the SLEEP DOC™, the child's brain should “learn” the more adequate way to shift stages. In this case, the act of enuresis is not “needed” any longer and it will spontaneously disappear. The SLEEP DOC™ is NOT intended to treat and/or cure but to help in switching one reflex (uncontrollable act of urination) to more adequate movement reflexes.

The position- and motion-sensitive vibrating device of the present invention comprises a vibrating member that is actuated, rather than constantly vibrating. In one embodiment, a person sleeps on the tool. After a predetermined amount of time, if the person has not made any movements of their own, gentle vibrations emanate from the tool. In an embodiment, the movement of the person is detected by sensing the tilt angle of the tool. In an embodiment, the device provides a tool for bedwetting control upon which a bedwetter may sleep.

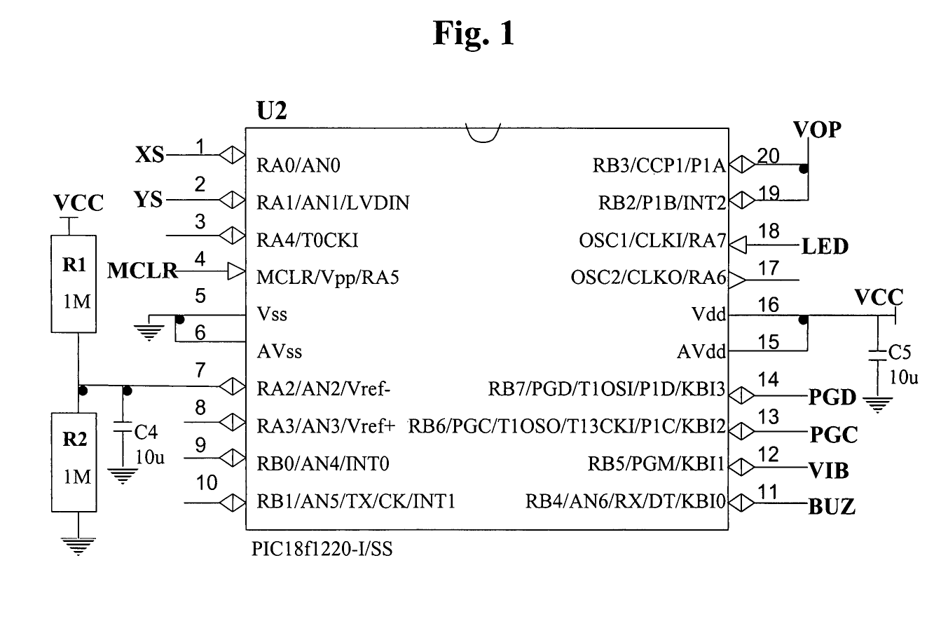

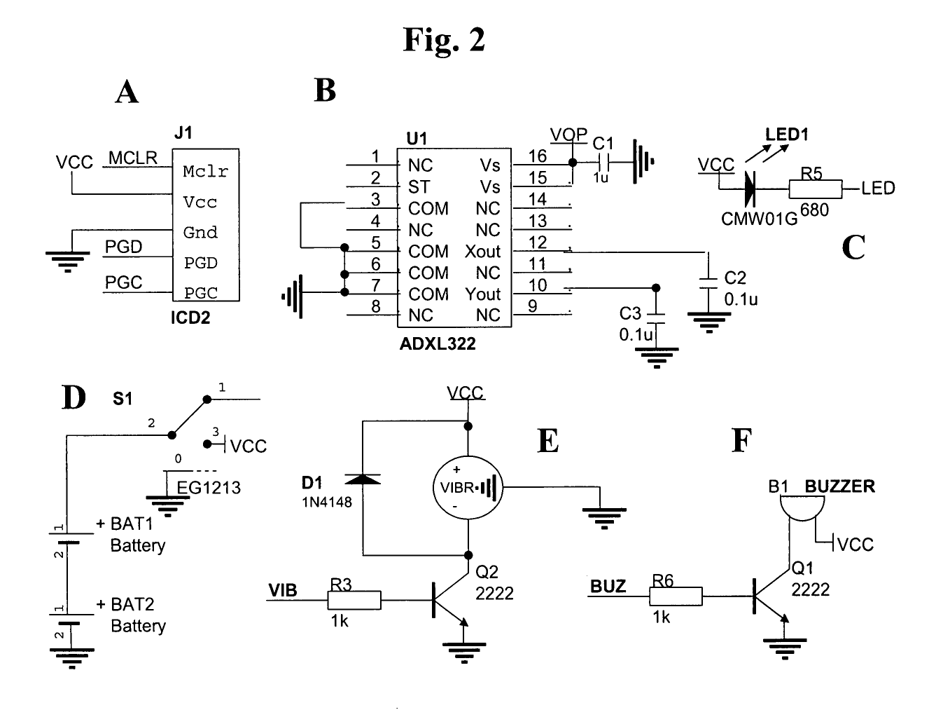

In an embodiment, the device is battery-operated. In one of those embodiments, such as the one shown in FIG. 1, a buzzer provides an alarm that the battery power is low. The invention also contemplates a plug-in version that does not require batteries, and a version that optionally runs off battery power or a power outlet.

In an embodiment, the device includes a microprocessor that can record, process and provide display information regarding the position and motion information. From such information, the sleep cycles can be evaluated.

The invention contemplates a vibrating means carried out by one of the many vibrating means known in the art, including but not limited to vibrant, oscillating, electrically driven, rotating, balls, one or multiple applicators, pinching, kneading, frictioning, reciprocating, belted, unbalanced weight, and gyratory vibrating means.

In the embodiment of the present invention whose circuit diagram is depicted in the attached Figure, the main components of the circuit are a microcontroller U2, accelerometer U1, buzzer B1, LED and vibrator motor M1. Q1 and Q2 are amplifier transistors that are used for the buzzer and the motor respectively.

During normal operation the microcontroller is constantly monitoring the acceleration using the 2-axis accelerometer. If the measurement is constant (i.e. the position of the device does not change) for a predetermined amount of time, the microcontroller causes the motor to be turned on periodically. Initially, a smaller voltage is applied to the motor. Then, if the position of the device still does not change, the voltage applied to the motor is increased. The microcontroller is able to control the effective power to the motor through pulse-width-modulation. Note that gravitational acceleration is also measured to determine the tilt angle of the device. This is accomplished by comparing the measured value to the reference value stored in a memory. This reference value of the acceleration for both axis corresponds to the device laying on a flat surface.

Other objects and features of the present invention will be obvious to those skilled in the art, upon contemplation of the disclosure herein in connection with the accompanying drawings. It is to be understood, however, that the drawing is designed for the purpose of illustration only and not as a definition of the instant invention.

### EXAMPLE 1

### Use of a Position- and Motion-Sensitive Device for Hygiene of a Young Person

A child of age 7 who suffers from bed-wetting sleeps on a position- and motion-sensitive device according to the present invention. The device includes accelerometers that provide information to the controller as to whether or not the accelerometer has been subjected to a force from the child's body. The time period for analysis of the child's body motion is preset for the most probable time wetting occurs for that child for the first half of the night in NREM sleep. During that time, when the child's body position has not moved in a predetermined amount of time (set from 10 minutes to 120 minutes, depending on the switch goal), quiet non-disturbing vibro-stimulation is emanated from the device. Once the sleeping child changes body position or moves, the position- and motion-sensitive controller turns off the vibratory stimulation until the next analysis period.

1. A motion-sensitive vibrating sleep device comprising a motion sensor that provides a signal when motion is sensed coupled to a controller that receives the signal when motion is sensed, wherein said controller causes a vibratory means to be activated when no motion signal is received in a predetermined period of time.
